(19) United States
(12) Patent Application Publication
(10) Pub. No.: US 2011/0273876 A1
(43) Pub. Date: Nov. 10, 2011

(54) THERMOPLASTIC STAKE MOUNTING SYSTEM AND METHOD

(76) Inventors: Mark Stolyar, Addison, TX (US); Vadim Zlotnikov, Dallas, TX (US)

(21) Appl. No.: 13/101,095

(22) Filed: May 4, 2011

Related U.S. Application Data
(60) Provisional application No. 61/331,139, filed on May 4, 2010.

(51) Int. Cl. F21V 11/00; B32B 37/10

(52) U.S. Cl. 362/235; 156/309.6

(57) ABSTRACT

A method and system for fastening an optical component having one or more thermoplastic stakes extending therefrom to a substrate is shown. The method and system include providing and inserting the thermoplastic stakes through openings in the substrate. An elastomeric compensator, such as a sheet, a washer, an o-ring, or other gasket-like piece, is then disposed around one or more of the thermoplastic stakes. The thermoplastic stakes are then heated and molded to form rivet-like heads and pressure is applied to compress the elastomeric compensators between the rivet-like heads and the substrate to pull the optical component against the substrate.

### CROSS-REFERENCE TO RELATED APPLICATIONS

This patent application claims priority from, and incorporates by reference for any purpose the entire disclosure of, U.S. Provisional Patent Application No. 61/331,139, filed May 4, 2010.

### BACKGROUND

1. Technical Field

The present invention relates generally to systems and methods for mounting components to a substrate using thermoplastic stakes, and more particularly, but not by way of limitation, to systems and methods for mounting optical lenses and/or optical reflector components to a substrate using thermoplastic stakes.

2. History of Related Art

In the assembly of many articles of manufacture, the fastening together of component parts needs to be rapid, efficient, and operational under varying conditions. A variety of methods have been used to fasten together such component parts. These methods include fastening with adhesive, metal clips, bolts, rivets, or staking Staking is the process of connecting two components by creating an interference fit between the two pieces. One work piece has a hole in it while the other has a boss that fits within the hole. The boss is undersized so that it has a slip fit. A staking punch is then used to compress the boss radially and form an interference fit between the workpieces. This forms a permanent joint.

Thermoplastic staking, also known as heat staking, is a type of staking where heat is used to deform a plastic boss, instead of cold forming. For example, a plastic stud protruding from one component may be slid into a hole in a second component. The plastic stud is then deformed through the softening of the plastic to form a head which mechanically locks the two components together. It is a versatile technique benefiting from being quick and economical. In addition, heat staking allows the simultaneous formation of a large number of studs and to accommodate a variety of stud head designs. Unlike welding techniques, staking has the capacity to join plastics to other materials (e.g., metal) in addition to joining like or dissimilar plastics and it has the advantage over other mechanical joining methods in eliminating the need for consumables such as rivets and screws. For example, heat staking has been used to join an acrylic-type tail light cover to a metal automobile body.

While there are many different methods of staking, the generally recognized methods of staking include: hot air/cold staking, ultrasonic staking, direct contact staking, and infrared staking Each of the methods are suitable for use under certain conditions and unsuitable under others. One problem with current heat-staking methods is that the quality of the joint is dependent on manufacturing parameters that often vary from part to part, such as the consistency of the shape of the two workpieces being joined together. The variability of these parameters means the quality of the stake will vary greatly from joint to joint.

### SUMMARY

A method and system for fastening a thermoplastic object having one or more projecting studs thereon to a substrate is shown. The method and system include providing and inserting thermoplastic stakes through an opening in the substrate. An elastomeric compensator, such as a sheet, a washer, an o-ring, or other gasket-like piece around the stakes is then provided for being disposed around the thermoplastic stake. The thermoplastic stake is then heated and molded to form a rivet-like head to compress the compensator between the rivet-like head and the substrate. In some embodiments, the washer may be formed of a rubberized or other elastomeric material that is compressed during molding to provide static pressure to pull the thermoplastic object against the substrate.

The above summary of the invention is not intended to represent each embodiment or every aspect of the present invention. It should be understood that the various embodiments disclosed herein can be combined or modified without changing the spirit and scope of the invention.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a cross-sectional side view of a plurality of thermoplastic studs inserted through a substrate before heat staking according to one embodiment;

FIG. 2 is a perspective view of a backside of an embodiment of a substrate having a plurality of thermoplastic studs and elastomeric compensators prior to heat staking;

FIG. 3 is a cross-sectional side view of the plurality of thermoplastic studs of FIG. 1 after heat staking;

FIG. 4 is a cross-sectional side view of a thermoplastic stud after heat staking;

FIG. 5 is a perspective view of a backside of the substrate of FIG. 2 having a plurality of thermoplastic studs inserted therethrough after heat staking;

FIG. 6 is a cross-sectional side view of a plurality of exemplary thermoplastic studs after heat staking;

FIG. 7 is a flow chart of a first embodiment of a heat staking process; and

FIG. 8 is a flow chart of a second embodiment of a heat staking process.

### DETAILED DESCRIPTION

In the manufacturing and assembly of lighting systems having light emitting diodes (LEDs), oftentimes the LEDs and/or other optical components such as optical lenses and/or reflectors are mounted onto a board, such as a printed wiring assembly (board). For example, PCT Application Publication No. WO 2010/027823, which is hereby incorporated by reference as if fully set forth herein, discloses an LED lighting system where a plurality of LEDs are mounted directly onto a board. Various mounting methods are disclosed therein, such as, for example, the use of spring-push rivets. However, the use of heat staking may provide various advantages over the mounting methods disclosed therein.

In assemblies containing on-board mounted LEDs and optical components such as lenses, magnifiers, covers, filters, diffusers, and/or reflectors, the optical performance of the LEDs depends on the repeatable dimensional consistency of the optical components. Variations in materials, conditions, and manufacturing parameters leads to size variations, which creates deleterious gaps between the board and the optical components mounted thereto. Such deleterious gaps may vary from component to component and from assembly to assembly. Oftentimes, the optical components mounted to the board enclose one or more of the LEDs and any movement of the optical components relative to the LEDs would negatively affect light distribution, optical performance, and mechanical performance of the assembled lighting system.

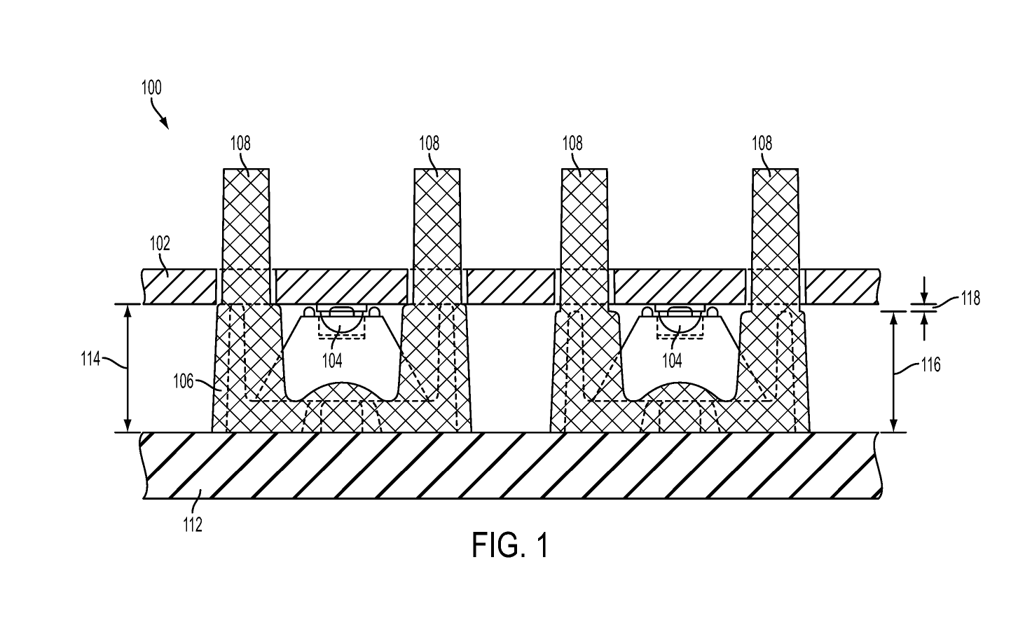

Referring now to FIG. 1, an embodiment of a lighting system 100 is shown during a manufacturing process. The lighting system 100 includes a board 102, such as a circuit board, a printed wireless assembly (PWA), or other support substrate, having a plurality of LEDs 104 mounted on a front side thereof. In the embodiment shown, optical components, such as lenses 106, are also disposed on the front side of the board 102 and encapsulating the LEDs 104. The lenses 106 are constructed with a plurality of thermoplastic stakes 108 projecting from a backside thereof. In various embodiments, the thermoplastic stakes 108 may be the same material as the lenses 106 or may be attached thereto or integrally formed therewith. As will be explained in more detail below, various physical characteristics of the thermoplastic stakes 108, such as length, width, and tapering, may be varied depending on the design criteria of the lighting system 100. In some embodiments, the thermoplastic stakes 108 and/or the lenses 106 may have one or more protrusions or indentations (not shown), such as, for example, teeth, to matingly engage the board 102 during the manufacturing process. In various embodiments, a single lens or other optical component may have a single thermoplastic stake or a plurality of thermoplastic stakes and may be adapted to encapsulate a single LED or a plurality of LEDs.

Still referring to FIG. 1, in the embodiment shown, the thermoplastics stakes 108 of the lenses 106 have been inserted into openings or holes in the board 102. In various embodiments, the lenses 106 may be held in place during the assembly process by a mounting plate 112. In some embodiments, the mounting plate 112 may be a generally flat surface or may contain indentions or other features on a surface thereof to temporarily hold the lenses 106 in place during the manufacturing process. In various embodiments, the mounting plate 112 may be disposed a predetermined distance (labeled 114 in FIG. 1) from the board 102. In various embodiments, one or more lenses 106 may have a height (labeled 116 in FIG. 1) less than or equal to the distance 114 between the board 102 and the mounting plate 112, thereby creating a gap 118 between a backside of one or more of the lenses 106 and the board 102.

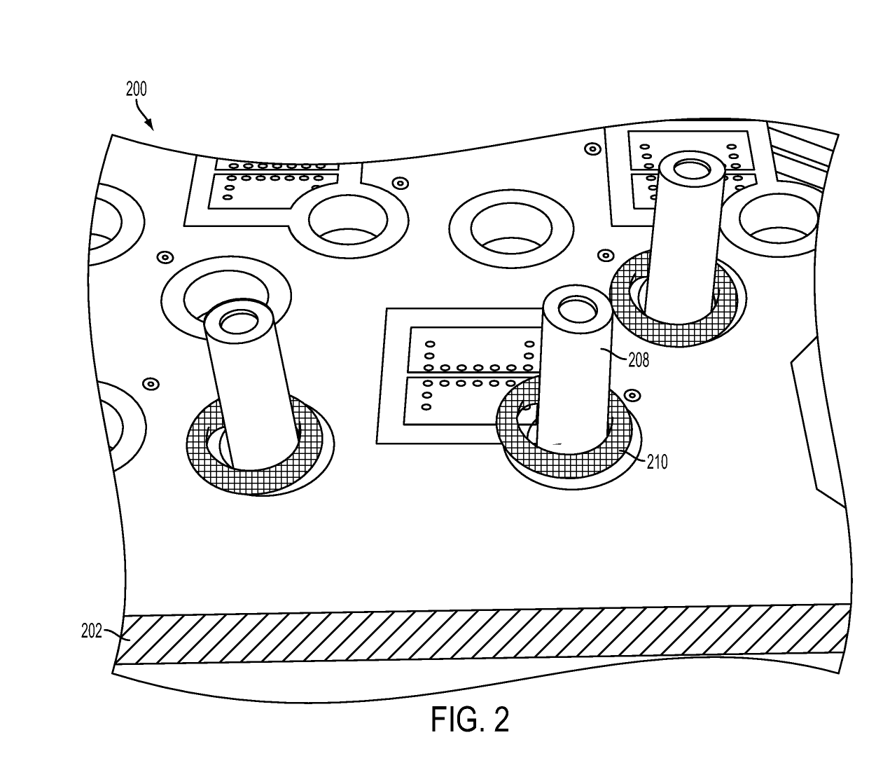

Referring now to FIG. 2, a backside of a lighting system 200 is shown during a manufacturing process with a board 202 having a plurality of holes disposed therethrough. In the embodiment shown, a plurality of thermoplastic stakes 208 have been inserted from a front side of the board 202 through some of the holes of the board 202 and extend out of the backside of the board 202. As will be explained in more detail below, a plurality of elastomeric compensators 210, have been disposed around each thermoplastic stake 208 on a backside of the board 202. In the embodiment shown, the elastomeric compensator 210 is an o-ring that has been disposed on a back side of the board 202. In various embodiments, the elastomeric compensator 210 may be any shape or size, such as, for example, a sheet, washer, or other elastomeric member. In the embodiment shown, the thermoplastic stakes 208 are cylindrical tubes having a hollow portion therein. As will be explained in more detail below, the walls of the thermoplastic stakes 208 may have a predetermined thickness depending on the design requirements of the lighting system 200. In various other embodiments, the thermoplastic stakes 208 may be any shape, may have a hollow portion extending only partially down the length thereof, and/or may not have any hollow portion.

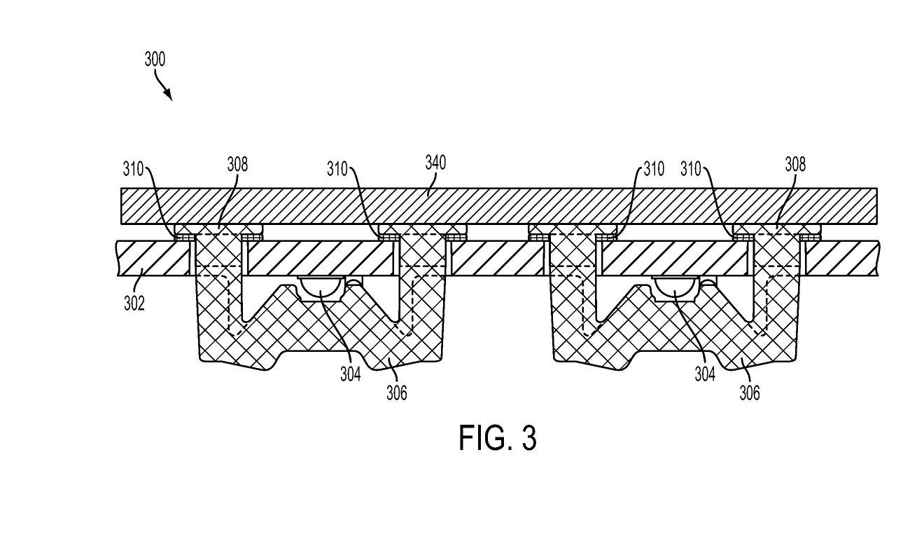

Referring now to FIG. 3, a cross-sectional side view of a lighting system 300 in accordance with an embodiment of the present invention can be seen wherein a plurality of lenses 306 have been mounted to a board 302. During the heat staking process, a plate 340 heats the thermoplastic stakes 308 until softened and applies pressure to the thermoplastic stakes 308 to flatten and widen them, thereby forming them into rivet-like heads to fasten the lenses 306 to the board 302. In various embodiments, the plate 340 may heat the thermoplastic stakes 308 to any temperature depending on the design characteristics and material used to form the thermoplastic stakes 308. For example, in one embodiment, the thermoplastic stakes 308 are heated to a range between 150°-200° C., however the thermoplastic stakes 308 may be heated to temperatures above or below this range. In various embodiments, the pressure applied by the plate 340 will depend on the number of thermoplastic stakes 308 to be compressed, the design characteristics and material used to form the thermoplastic stakes 308, and the temperature to which the thermoplastic stakes 308 are heated. In various embodiments, the plate 340 may apply pressure on the order of 10-20 lbs per thermoplastic stake. For example, in an embodiment having 10 thermoplastic stakes 308, the manufacturing process may call for the plate 340 to provide 150 lbs of force.

Still referring to FIG. 3, as can be seen, during creation of the rivet-like head, the elastomeric compensators 310 are compressed between the rivet-like heads of the thermoplastic stakes 308 and the board 302. The compressed elastomeric compensators 310 thus create static pressure that pulls the lenses 306 flush with the board 302 to securely mount the lenses 306 thereto. In various embodiments, a portion of the elastomeric compensator 310 may also be drawn in between the thermoplastic stakes 308 and the holes in the board 302 thus providing self-centering media within the holes of the board 302. In the embodiment shown, the utilization of elastomeric compensators 310 allows a single plate 340 and a single mounting plate (shown as 112 in FIG. 1) to be utilized to form rivet-like heads on a plurality of thermoplastic stakes 308 in a single step. While plate 340 and/or supporting structure 112 may be specially formed based on the layout of the lenses 306, the mounting method and system does not require them to be specially formed thus allowing a generally flat plate 340 and/or mounting plate to be utilized in the manufacture of a plurality of different designs and/or layouts. In various embodiments, the elastomeric compensators 310 may be silicon, rubber, polymer, elastomer, or other elastic-type material. In various embodiments, the physical characteristics, such as thickness and stiffness, of the elastomeric compensators 310 used in the manufacturing process are predetermined based on the maximum amount of variability in the height of the lenses. For example, the elastomeric compensators 310 would need to be thick enough and/or stiff enough to overcome the largest gap (shown as 118 in FIG. 1) between any of the lenses and the board.

Still referring to FIG. 3, during operation of the lighting system 300, temperature fluctuations often causes thermal expansion of the various components of the lighting assembly 300. In various embodiments, the elastomeric compensators 310 provide compensation for variations resulting from the thermal expansion of dissimilar components and materials, thus keeping the optical components 306 tightly coupled to the board 302. In addition, the elastomeric compensators 310 may provide vibration dampening and shock absorption to the lighting system 300.

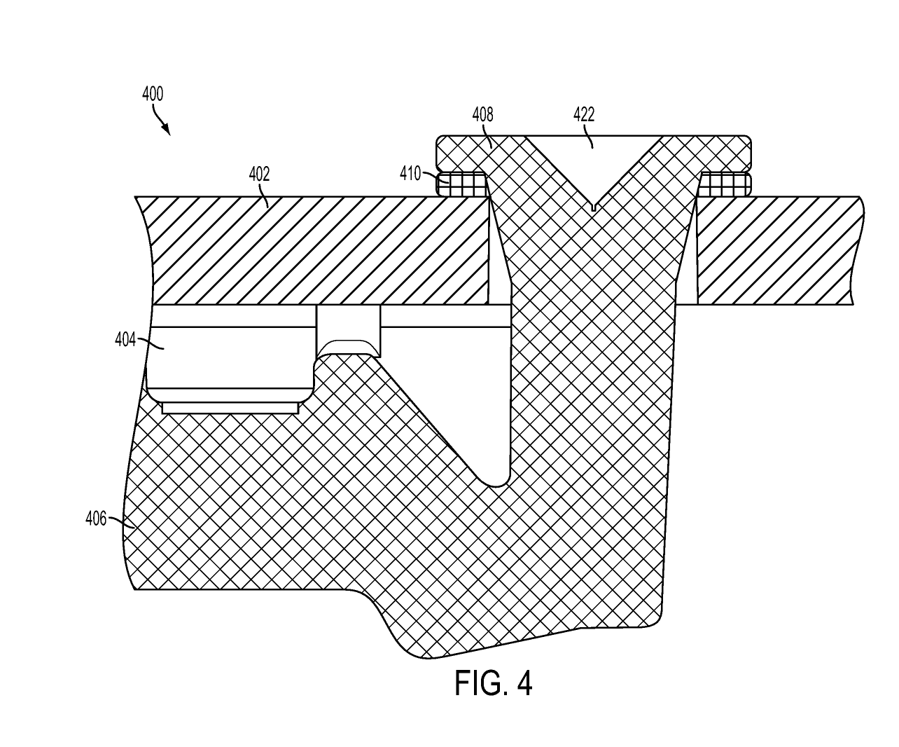

Referring now to FIG. 4, a cross-sectional side view of a single thermoplastic stake 408 of a single lens 406 of a lighting system 400 is shown after the thermoplastic stake 408 has been formed into a rivet-like head. As can be seen, during the heat-staking process an elastomeric compensator 410 has been compressed between the rivet-like head of the thermoplastic stake 408 and the board 402. In the embodiment shown, the rivet-like head can be seen having an indentation 422 in a central portion thereof. In various embodiments, the indentation 422 may be formed as a result of the thermoplastic stake 408 having a hollow portion therein (as shown in FIG. 2). Before the heat-staking process, the thermoplastic stake 408 has predetermined physical dimensions, such as diameter, height, and tapering. During the heat-staking process, a portion of the thermoplastic stake 408 is formed into a rivet-like head having a predetermined diameter and thickness. The physical dimensions of the thermoplastic stake 408 before heat-staking are calculated based on the design criteria of the lighting system 400 to reduce weight while at the same time providing a sufficient volume of thermoplastic material to form a rivet-like head that is strong enough to counteract forces applied to the lens 406. As can be seen, providing more material to form the rivet-like head will result in a larger rivet-like head having a larger diameter and thickness.

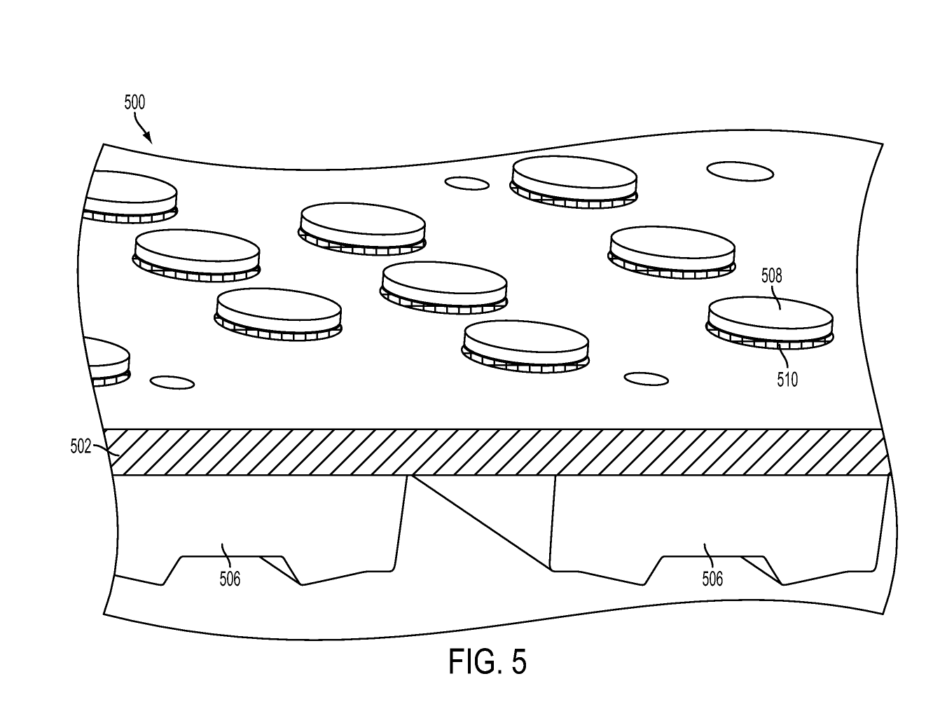

Referring now to FIG. 5, a perspective view of a backside of a lighting system 500 is shown. In the embodiment shown, a backside of a board 502 can be seen having a plurality of lenses 506 disposed on a front side thereof and a plurality of rivet-like heads formed on a backside thereof from thermoplastic stakes 508 passing through the board 502. Each thermoplastic stake 508 has an elastomeric compensator 510 disposed therearound and interposed between the backside of the board 502 and an underside of the rivet-like heads formed from the thermoplastic stakes 508 during the heat-staking process.

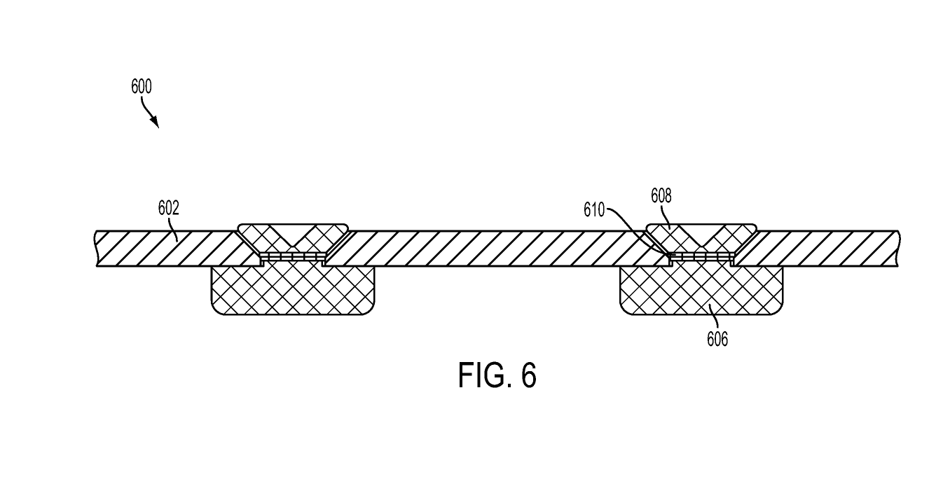

Referring now to FIG. 6, a cross-sectional side view of a lighting system 600 is shown having a plurality of lenses 606 mounted to a board 602. In the embodiment shown, the board 602 has a plurality of countersunk holes disposed on a backside thereof. During the heat staking process, the rivet-like heads formed from the thermoplastic stakes 608 conform to the shape of the countersunk holes on the backside of the board.

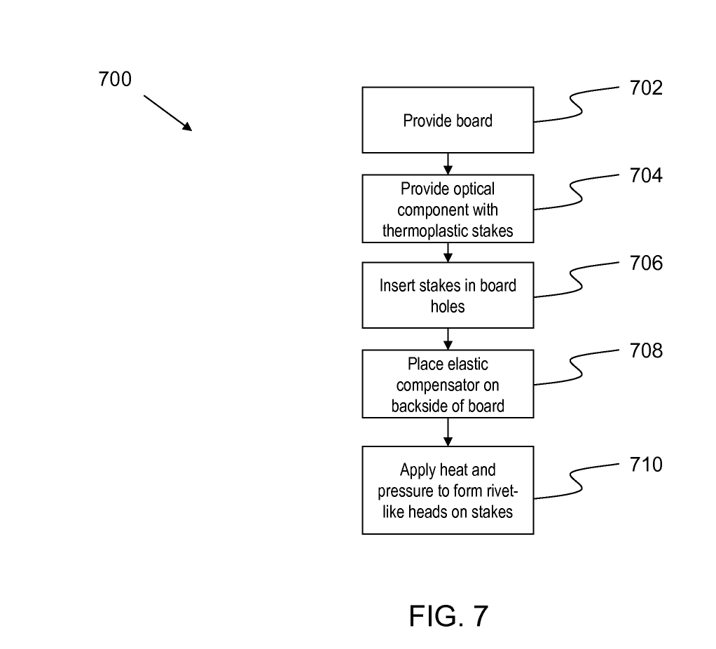

Referring now to FIG. 7, an embodiment of a method 700 of mounting an optical component, such as a lens, to a circuit board, such as a board is shown. The method begins at step 702 by providing a board onto which an optical component is to be mounted. The optical component having thermoplastic stakes is then provided at step 704. At step 706, the thermoplastic stakes are inserted into holes disposed in the board. Next, an elastomeric compensator is placed around each thermoplastic stakes on a backside of the board at step 708. Then, at step 710, heat and pressure is applied to the thermoplastic stakes to form rivet-like heads thereon.

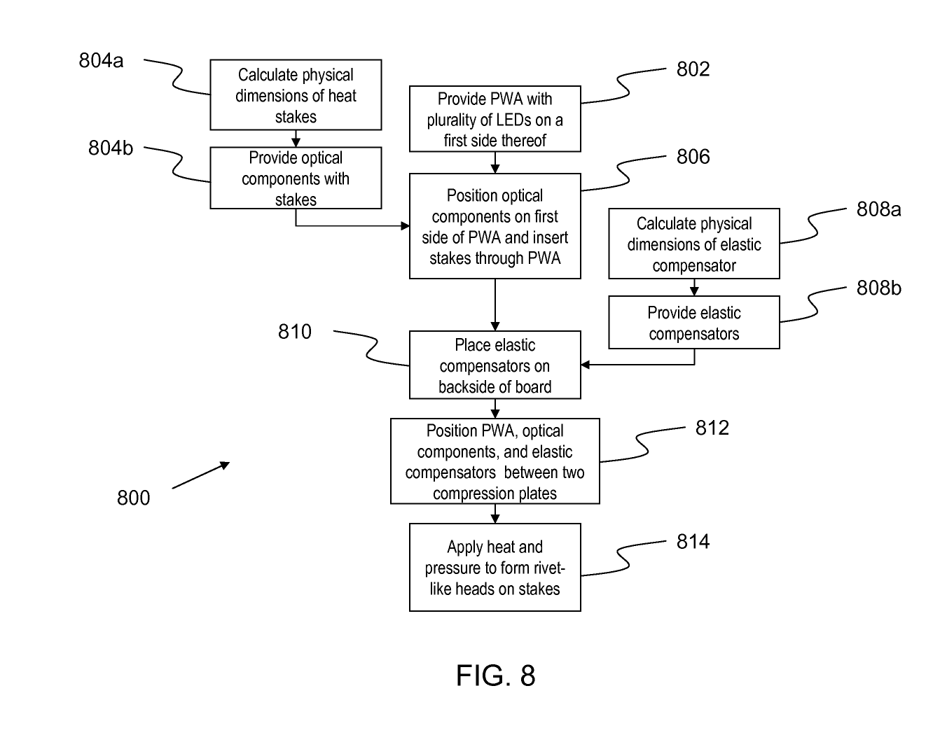

Referring now to FIG. 8, an embodiment of a method 800 of mounting an optical component, such as a lens, to a board, such as a circuit board or PWA, is shown. The method 800 begins at step 802 with a board having a plurality of LEDs mounted thereon being provided. At step 804a, physical dimensions of thermoplastic stakes are calculated, such as, the material to be used, the height, diameter, tapering, and thickness of walls of the thermoplastic stakes. At step 804b, a plurality of optical components are provided with thermoplastic stakes protruding therefrom having the calculated physical dimensions. At step 806, the optical components are positioned on a first side of the board and the thermoplastic stakes are inserted through holes in the board. At step 808a, physical dimensions of elastomeric compensators are calculated, such as, the material to be used and the thickness and stiffness of the elastomeric compensators. At step 808b, a plurality of elastomeric compensators are provided having the calculated physical dimensions. At step 810, the elastomeric compensators are placed around the thermoplastic stakes on a back side of the board. At step 812, the board, optical components, and elastomeric compensators are interposed between two compression plates. At step 814, heat and pressure is applied to form the thermoplastic stakes into rivet-like heads.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method of securing an optical component to a support surface having a plurality of light emitting diodes (LEDs) mounted thereon, the method comprising:
providing a support surface with first and second opposite sides having a plurality of holes disposed therethrough and a plurality of LEDs mounted on the first side thereof;
positioning at least one optical component over one or more of the plurality of LEDs on the first side of the support surface, the at least one optical component having a plurality of thermoplastic stakes extending from a back surface thereof;
for each thermoplastic stake of the plurality of thermoplastic stakes, inserting an end thereof through a hole of the plurality of holes in the support surface such that the end projects outwardly from the second side of the support surface;
disposing elastomeric compensators around the plurality of thermoplastic stakes projecting outwardly from the second side of the support surface;
interposing the support surface and the at least one optical component between first and second plates; and
utilizing the first and second plates to apply heat and pressure to the ends of the thermoplastic stakes to form the ends thereof into rivet-like heads and compress the elastomeric compensator between the rivet-like head and the second side of the support surface.

2. The method of claim 1, wherein the optical component is a lens.

3. The method of claim 1, wherein at least one hole of the plurality of holes is countersunk from the second side of the support surface.

4. The method of claim 3, wherein at least one thermoplastic stake of the plurality of thermoplastic stakes extends through the at least one countersunk hole and the rivet-like head formed therefrom at least partially conforms to the countersunk hole.

5. The method of claim 1 and further comprising:
calculating a volume of thermoplastic material needed to form a rivet-like head having a predetermined diameter and thickness; and
providing the at least one optical component having thermoplastic stakes with physical dimensions based upon on the volume calculated.

6. The method of claim 1 and further comprising:
determining variability in heights of the plurality of optical components;
providing the elastomeric compensators having a thickness greater than the determined variability.

7. The method of claim 1 and further comprising:
calculating physical dimensions of the rivet-like heads needed to withstand a threshold force applied to the at least one optical component; and
providing the at least one optical component having thermoplastic stakes with lengths and widths based upon the physical dimensions calculated.

8. The method of claim 1, wherein the plurality of thermoplastic stakes are tubularly shaped with at least a portion thereof being hollow.

9. The method of claim 8, wherein the tubularly shaped thermoplastic stakes a have walls of a predetermined thickness based upon a volume of thermoplastic material needed to form a rivet-like head having a predetermined size.

10. A method of securing an optical component to a board having a plurality of light emitting diodes (LEDs) mounted thereon, the method comprising:
providing a board having a plurality of holes disposed therethrough and a plurality of LEDs mounted on a first side thereof;
providing a plurality of optical components to be mounted to the board, each optical component having a plurality of thermoplastic stakes protruding therefrom;
inserting the plurality of thermoplastic stakes into the holes from the first side, through the board, and extending outwardly from a second side of the board opposite the first side;
positioning an elastomeric compensator around each thermoplastic stake on the second side of the board;
positioning the board, the optical components, and the elastomeric compensators between a first surface and a second, generally flat surface for applying pressure thereto; and
moving the first and second surfaces toward each other while applying heat to the plurality of thermoplastic stakes to form a rivet-like head on each thermoplastic stake and to compress the elastomeric compensator between the rivet-like head and the second side of the board.

11. The method of claim 10, wherein at least one hole of the plurality of holes having a thermoplastic stake passing therethrough is countersunk from the second side of the board and the rivet-like head formed on the thermoplastic stake at least partially conforms to a shape of the countersunk hole.

12. The method of claim 10 and further comprising:
determining a variability of a physical dimension of the plurality of optical components; and
providing the elastomeric compensator having a thickness greater than the variability of the physical dimension.
of the based on manufacturing variability of the plurality of optical components.

13. The method of claim 10 and further comprising:
calculating a minimum surface area of the rivet-like head needed to withstand a threshold force applied to an optical component of the plurality of optical components; and
providing thermoplastic stakes having lengths and widths based upon the minimum surface area calculated.

14. The method of claim 10, wherein all of the rivet-like heads are formed at the same time.

15. A lighting system having a plurality of light emitting diodes (LEDs) mounted on a circuit board and encapsulated by one or more optical components, the lighting system comprising:
a board having a generally flat mounting surface, a backside surface oppositely disposed from the mounting surface, and a plurality of holes extending from the mounting surface to the backside surface;
a plurality of LEDs mounted to the mounting surface;
at least one optical component disposed over one or more of the plurality of LEDs and abutting the mounting surface of the board;
a plurality of thermoplastic stakes extending from the at least one optical component, passing through holes of the plurality of holes, and projecting outwardly from the backside surface of the board;
a plurality of rivet-like heads disposed along the backside surface of the board and formed from the plurality of thermoplastic stakes; and
a plurality of elastomeric compensators disposed on the backside surface of the board, each elastomeric compensator being disposed around a thermoplastic stake of the plurality of thermoplastic stakes and compressed between a rivet-like head of the plurality of rivet-like heads and the backside surface of the board.

16. The lighting system of claim 15, wherein the elastomeric compensators bias the rivet-like heads away from the backside surface of the board.

17. The lighting system of claim 15, wherein the elastomeric compensators have a thickness greater than a variability in heights of the plurality of optical components.

18. The lighting system of claim 15, wherein at least one of the rivet-like heads have a recess disposed therein on a backside thereof.
